(19) United States
(12) Patent Application Publication
(10) Pub. No.: US 2019/0219215 A1
(43) Pub. Date: Jul. 18, 2019

(54) MOBILE ROBOTIC DEVICE WITH IMPROVED ARCHIMEDEAN SCREW PROPULSION MECHANISM

(71) Applicant: COMMISSARIAT À L'ÉNERGIE ATOMIQUE ET AUX ÉNERGIES ALTERNATIVES, Paris (FR)

(72) Inventor: Gwenael Changeon, Paris (FR)

(21) Appl. No.: 16/337,107

(22) PCT Filed: Oct. 2, 2017
(86) PCT No.: PCT/FR2017/052693

§ 371 Date: Mar. 27, 2019

(30) Foreign Application Priority Data
Oct. 4, 2016 (FR) 16 59576

(51) Int. Cl. F16L 55/32

(52) U.S. Cl. CPC F16L 55/32; F16L 2101/30

(57) ABSTRACT

A mobile robotic device comprising a propulsion mechanism equipped with an Archimedean screw, so as to allow it to move over various types of ground. The mobile robotic device comprises a body and a propulsion mechanism, the propulsion mechanism comprising: a drum capable of rotating with respect to the body, and Archimedean screw thread projecting from an exterior surface of the drum, and rolling members each one comprising a support structure and a wheel, each support structure forming a portion of the screw thread and each wheel being mounted as a pivot connection on the support structure, each rolling member comprising at least one cavity designed to minimize the adjacent surface areas between the support structure and the wheel.

### TECHNICAL FIELD

The invention is in the field of mobile robots and more specifically in the field of robots moved by one or more Archimedean screws. It relates to such a mobile robotic device equipped with one or more propulsion mechanisms each comprising an Archimedean screw, so as to permit movement of the robotic device on a rigid support, in the presence of water, sand, grease or mud.

The invention applies particularly to the inspection of pipes, for example rain water pipes, sewage pipes and industrial pipes. More generally, the invention finds application for any deployment of a mobile robot on difficult terrain, for example soft, wet and/or granular terrain.

### State of the Art

Mobile mechatronic devices are used to move within urban or industrial pipe networks in order to carry out inspections, for example by means of images or taking various physical and/or chemical measurements. Locomotion function of such devices is generally made possible using wheels or tracks. In the presence of water, sand or mud, these devices may find their progress blocked. To avoid such blocking it is possible to scour the pipe to be inspected before the device is inserted. However, the scouring operation leads to disadvantages in terms of speed of response, complexity and cost.

In order to enable a mobile robot to move on difficult terrain, one possibility is to equip it with a propulsion mechanism comprising an Archimedean screw. The thread of the Archimedean screw engages the ground and enables movement regardless of surface type, the screw thread penetrating, roughly, the ground. For example, the company Steady Flux, Inc. proposes a pipeline inspection device, called a CBOR, operating such an Archimedean screw. The device comprises an elongated central body and a pair of Archimedean screws arranged on either side of the central body and connected thereto by a pivot connection via arms. A disadvantage of such a robot is that propulsion by Archimedean screws on relatively hard ground causes the screws to slide significantly. Then, the robot consequently loses traction and the Archimedean screw threads sustain wear. The energy loss is more damaging since the robot is usually powered by onboard power supply means.

The applicant has proposed solutions to these problems in patent application PCT/EP2015/070612, which is not yet published. According to one embodiment of the invention, the robotic inspection device comprises a rotary drum whose outer surface has an Archimedean screw thread, each thread being equipped with wheels which can be driven in rotation by contact with the ground upon rotation of the corresponding drum. The presence of the wheels improves traction and reduces friction between the robotic inspection device and the ground on which it operates. However, in the presence of various foreign bodies of small dimensions such as sand or gravel, the wheels become blocked in rotation due to the presence of foreign bodies between them and their support member. Therefore, the friction can be substantial, especially if the wheels have an elastomeric material tread allowing a better grip on hard ground.

According to another embodiment, compatible with the previous one, the Archimedean screw threads are removably mounted on rotary drums. Each thread is formed by a plurality of thread portions each adapted to be removably mounted on a rotary drum, for example by locking of pins integral to the thread portions in complementary holes formed on the rotary drum. The removable nature of the thread makes it possible to replace it without replacing the whole of the rotary drum and, if necessary, without disassembling any components located inside the rotary drum. However, the risk of friction remains high, either because of the absence of wheels or because wheel locking due to foreign bodies.

The aforementioned solutions for reducing friction during movement of the mobile robot do not therefore provide a fully satisfactory solution. Therefore, an object of the invention is to provide a solution to reduce this friction regardless of the type of surface encountered by the mobile robot.

### SUMMARY OF THE INVENTION

To this end, the invention relies on two main branches of development, independent but synergistic. In each branch of the invention, the mobile robotic device has a body and at least one propulsion mechanism, the latter comprising a rotary drum provided with an Archimedean screw thread and rolling members each having a support structure and a wheel. Each support structure forms a portion of the thread and each wheel is mounted pivotally connected to the support structure to allow translation of the drum along its axis of rotation while minimizing friction with the pipe.

According to a first branch of the invention, each rolling member comprises one or more recesses arranged so as to minimize the adjacent surfaces between the support structure and the wheel of the rolling member concerned. Adjacent surfaces between the support structure and the wheel refer to the wheel surface(s) and the support structure(s) having a minimum distance therebetween. These areas can particularly be parallel.

More precisely, the first branch of the invention relates to a mobile robotic device comprising a body and a propulsion mechanism. The propulsion mechanism comprises:
a drum adapted to be driven in rotation relative to the body,
an Archimedean screw thread integral with the drum and projecting with respect to an outer surface of the drum, and
rolling members each having a structure support member and a wheel, each support structure forming a portion of the thread and each wheel being mounted in pivot connection on the support structure so as to be driven in rotation by contact with a wall of the pipe upon rotation of the drum, each rolling member comprising at least one recess arranged to minimize the adjacent surfaces between the support structure and the wheel.

The presence of one or more recesses (e.g. at least two or at least three) at each rolling member has the effect of reducing the adjacent surfaces between the support structure and the wheel, compared to a rolling member without a recess for which surfaces of the wheel and the support structure facing each other are relatively large. The recesses have the further effect of introducing a variable spacing between the two surfaces of the wheel and the support structure facing each other. This variable spacing makes it possible to drive in rotation along the axis of rotation of the wheel any foreign objects caught between the wheel and the support structure to send them to the outside of the rolling member.

The recesses may be formed in the support structure and/or the wheel in different rolling members.

Each recess may have an opening passing through either the support structure or the wheel. Preferably, the opening is formed so as to traverse the piece in question from one side along an axis parallel to an axis of wheel rotation of the pivot connection on the corresponding support structure. Such openings permit the evacuation of foreign bodies introduced in the rolling members.

According to a first particular embodiment, each wheel comprises a hub, a rim and spokes extending radially between the hub and the rim, the spokes being separated from one another so as to form openings in the wheel. These openings are then traversing to the wheel.

Advantageously, the spokes of each wheel have a cylindrical or frustoconical shape. Such a shape makes it possible to limit the scope of the parallel surfaces between a wheel and its support structure.

According to a second particular embodiment, the spokes are replaced by a side wall which may have a continuous surface. Each wheel then comprises a hub, a rim and said side wall, which extends radially between the hub and the rim and is facing a surface of the support structure. One or several recesses may be formed on the side wall. This particular embodiment is particularly suitable for wheels having a relatively large width. Width of the wheel, refers to its dimension along its axis of translation.

Each wheel can of course comprise two side walls, each side wall coming opposite a surface of the support structure. Therefore, the recesses are preferably formed on both side walls.

In this second particular embodiment, each recess may be arranged to form a blind hole in the relevant side wall.

Also in this second particular embodiment, the wheel may include a plurality of recesses circumferentially distributed on the relevant side wall.

According to a particular embodiment, each support structure forms a lattice frame. Lattice structure refers to an integral assembly of beams. Openings are formed between the beams and are recesses within the meaning of the present invention.

According to a second branch of the invention, independent of the first branch but combinable therewith, the support structure of each rolling member is arranged to be able to deform under the effect of an external force. In particular, the support structure may be arranged to be able to deform under the effect of the introduction of a foreign body between the wheel and the support structure. Preferably, the deformation is elastic, at least for any introduction of a foreign body the largest dimension of which is less than or equal to twice the minimum distance separating the wheel from its support structure. Thus, the clearance between the wheel and the support structure is adapted to vary, making it possible for removing the foreign bodies.

More specifically, the second part of the invention relates to a mobile robotic device comprising a body and a propulsion mechanism. The propulsion mechanism comprises:
a drum adapted to be driven in rotation relative to the body,
an Archimedean screw thread integral with the drum and projecting with respect to an outer surface of the drum, and
rolling members each comprising a structure support and a wheel, each support structure forming a portion of the thread and each wheel being mounted in pivot on the support structure so as to be drivable in rotation by contact with a wall of the pipe upon rotation of the drum, the support structure of each rolling member being arranged to be able to deform under the effect of an external force.

The deformation of the support structure can be obtained by selecting materials and/or dimensions suitable for the flexible structure. Preferably, no articulation mechanism is provided in the support structure to ensure its deformation.

According to a first particular embodiment, the support structure of each rolling member comprises an arm having a first end integral with the drum and a second end carrying a wheel hub, the arm being arranged to be capable of bending under the effect of an external force.

According to a second particular embodiment, the support structure of each rolling member comprises an arm having a first end and a second end integral with the drum, a midpoint of the arm carrying a hub of the wheel and the arm being arranged to be able to bend under the effect of an external force.

In this second embodiment, the arm may extend between its two attachment points following different profiles. In particular, the arms may extend linearly between its two attachment points, following a curved profile or following a sinuous profile.

In each embodiment, the support structure of each rolling member may comprise two arms connecting the wheel to the drum by a pivot connection. The arms are advantageously arranged on either side of the wheel, to permit movement of the wheel along an axis perpendicular to the local mean plane of the drum.

The support structure of each rolling member is preferably made of an elastic material. This is, for example, a thermoplastic polymer such as polycarbonate, or an elastomer such as rubber.

Regardless of which branch of the invention that is considered, the mobile robotic device may comprise one or more of the characteristics listed below.

The Archimedean screw thread may extend spirally along the rotation axis of the drum. It can extend over the entire length of the drum or only partially.

The Archimedean screw thread and, in particular, the support structures of the different rolling members, may be made integral with the drum, for example by an injection moulding process or by three-dimensional printing. Alternatively, the support structures of the different rolling members may form elements removable from the drum. The support structures are for example fixed to the drum by a locking mechanism. In particular, the support structures may be equipped with pins adapted to lock into openings formed on the outer surface of the drum.

Each wheel is preferably pivotally connected to a support structure along an axis of rotation perpendicular to a median plane of the local support structure. In other words, the circumference of the wheel substantially follows the route of the thread of the Archimedean screw.

The robotic device may comprise a plurality of propulsion mechanisms, each propulsion mechanism comprising a drum, an Archimedean screw thread integral with the drum and rolling members whose support structures each form a portion of the thread and whose wheels are each mounted pivotally in a support structure.

Propulsion mechanisms are fitted preferably to the robotic device in pairs, the propulsion mechanism of a pair being disposed symmetrically relative to a median plane of the device, that is to say a vertical plane parallel to an axis of movement of the robotic device when it is on a horizontal plane.

Each propulsion mechanism is intended to be equipped with a motor, for example an electric motor, adapted to drive the drum in rotation relative to the body. The robotic device may further include an accumulator for each electric motor or a common accumulator for the various electric motors arranged to provide said engines with electrical energy.

The robotic device is intended, for example, for inspection and/or reconnaissance operations. To this end, it may include various sensors, such as an image sensor or a video camera.

### BRIEF DESCRIPTION OF THE DRAWINGS

The invention will be better understood using the following description, only provided as a non-limiting example and with reference to the accompanying drawings in which:

FIG. 1 shows a mobile robotic device developed by the applicant;

FIG. 2 shows a detail of an embodiment of the mobile robotic device of FIG. 1;

FIG. 3A shows a first example of a propulsion mechanism of a mobile robotic device according to the invention and FIGS. 3B, 3C and 3D show a detail of an embodiment of the propulsion mechanism;

FIG. 4A shows a second example of a propulsion mechanism of a mobile robotic device according to the invention and FIG. 4B shows a detail of an embodiment;

FIG. 5 shows a detail of a third exemplary embodiment of a propulsion mechanism for a mobile robotic device according to the invention;

FIG. 6 shows a detail of a fourth exemplary embodiment of a propulsion mechanism for a mobile robotic device according to the invention;

FIG. 7 shows a detail of a fifth exemplary embodiment of a propulsion mechanism for a mobile robotic device according to the invention.

### DETAILED DESCRIPTION OF SPECIFIC EMBODIMENTS

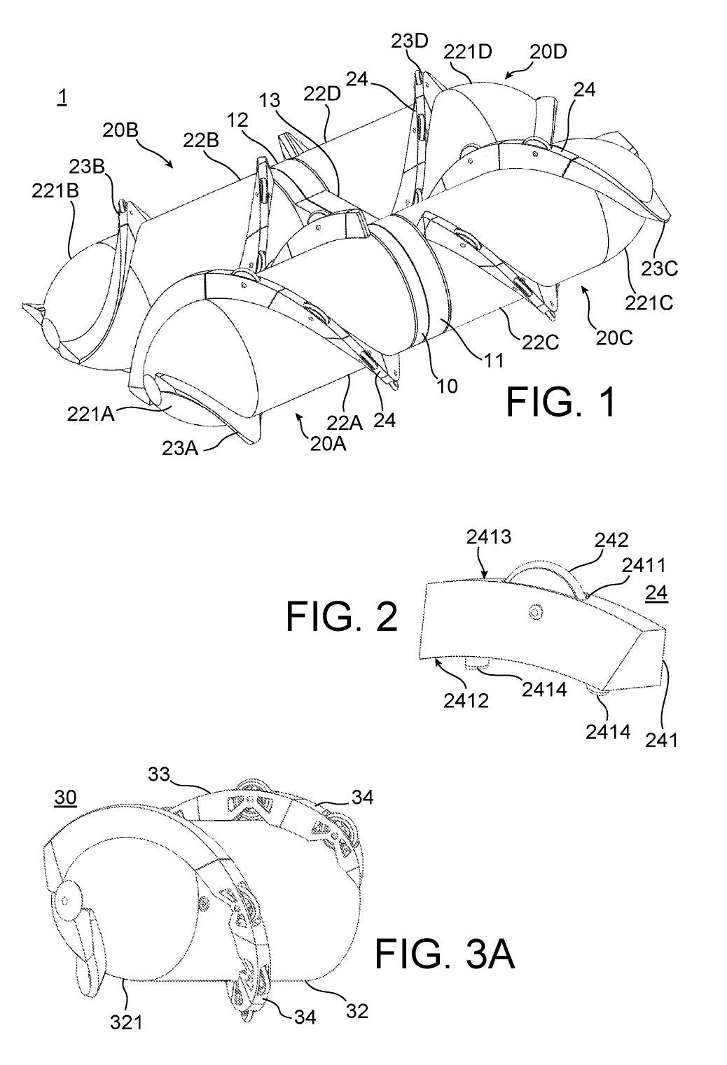

FIG. 1 shows a mobile robotic device according to one of the embodiments described in the patent application PCT/EP2015/070612. The mobile robotic device 1 comprises a body 10 and four propulsion mechanisms 20A, 20B, 20C, 20D. The propulsion mechanisms 20A, 20B, 20C, 20D are generally designated by the reference 20, i.e. omitting the final letter of the individual references. Similarly, the various parts and the different parts of the propulsion mechanisms are individually designated with a final letter A, B, C or D and generally without a final letter. Each propulsion mechanism 20 comprises a drum 22, an Archimedean screw thread 23 and rolling members 24. Each drum 22 has a hollow cylindrical shape, open at one end and terminated at a second end by a dome 221. Each drum 22 is mounted in pivot connection with respect to the body 10 along an axis of rotation. The rotational axes of the drums 22A and 22C coincide, as well as the axes of rotation of drums 22B and 22D. In addition, the rotational axes of the drums 22A and 22C are parallel to the rotation axes of drums 22B and 22D. The drums 22 have the same diameter. The body 10 is formed by an armature comprising four tubes, not visible in FIG. 1, two rings 11, 12 and a connecting member 13. Each tube is housed inside of a drum 22 and includes an electric motor adapted to drive the drum 22 in rotation relative to the body 10. The rings 11 and 12 are positioned between the open ends of the drums 22. Their outer surface is arranged to conform to the outer surface of the drum 22. The ring 11 integrally connects the tubes of drums 22A and 22C and the ring 12 integrally connects the tubes of drums 22B and 22D. The connecting member 13 integrally connects the rings 11 and 12, so that the body 10 forms a rigid frame for the device 1. The Archimedean screw thread 23 of each propulsion mechanism 20 is mounted integrally on the outer surface of the corresponding drum 22. It extends spirally over the entire length of the drum 22 and extends over the dome 221 until its top. The thread 23 is partly formed by the rolling members 24, which are removably mounted on the drum 22.

FIG. 2 shows in more detail a rolling member 24 of the mobile robotic device 1 of FIG. 1. The rolling member 24 includes a support structure 241 and a wheel 242. The support structure 241 has a shape and dimensions arranged to form a portion of the Archimedean screw thread 23. Overall, as can be seen in FIG. 1, the support structures 241 of the various rolling members 24 mounted on a drum 23 form a continuous structure in the form of Archimedean screw. The Archimedean screw threads 23A and 23C have a right-hand thread and the Archimedean screw threads 23B and 23D have a left-hand thread. Thus, along to the direction of rotation of the drums 23, the mobile robotic device 1 can move rectilinearly, along an axis parallel to the rotation axes of the drums 23, or rotate about a vertical axis. The support structure 241 forms a solid part, except in that it includes a housing 2411 arranged to accommodate the wheel 242. The housing 2411 is passing through between a lower surface 2412, i.e. a surface coming into contact with the drum 22, and a top surface 2413, i.e. an opposite surface intended to come into contact with the ground. At the very least, the housing 2411 must lead to the upper surface 2413 so as to allow the wheel 242 to protrude with respect to that surface. The support structure 241 further includes pins 2414 formed on the bottom surface 2412. The pins 2414 are intended to lock into openings formed on the outer surface of drum 23. The rolling members 24 thus form easily interchangeable components. The wheel 242 is arranged in the housing 2411 and pivotally mounted on the support structure 241. The axis of the pivot connection is arranged so that the rolling surface 2421 of the wheel 242 follows the profile of the portion of thread 23.

The mobile robotic device 1 described with reference to FIGS. 1 and 2 has the disadvantage that foreign bodies of small dimensions, such as gravel or sand, may become lodged between the wheels 242 and their support structure 241 and hinder, or even stop, rotation of the wheels 242.

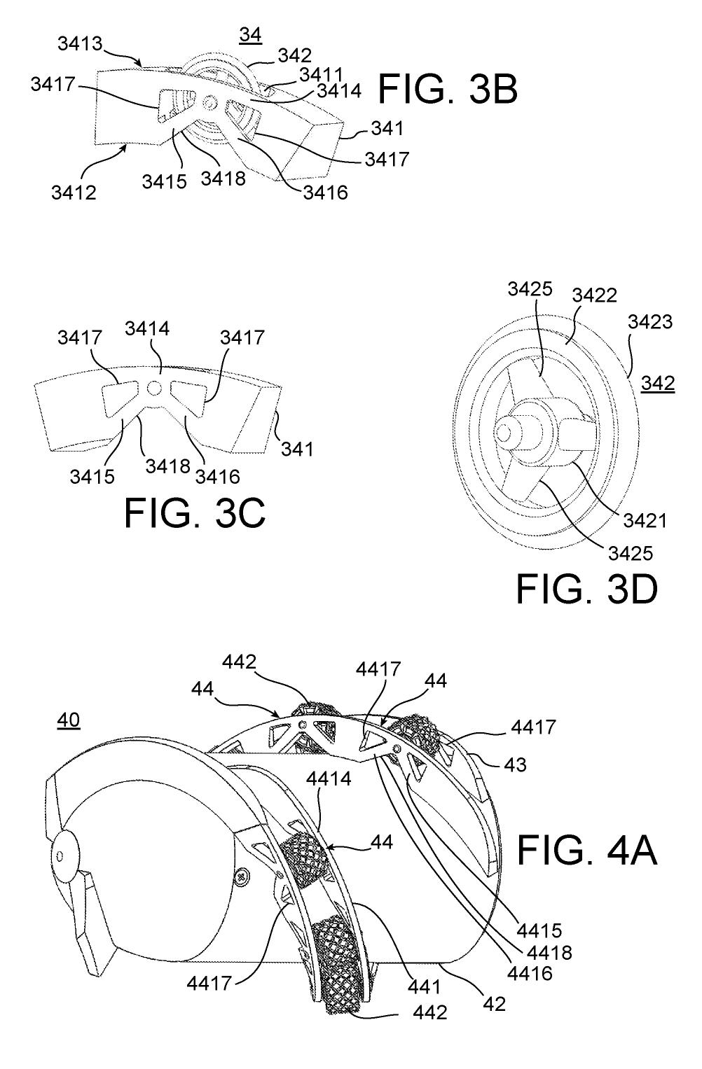

FIG. 3A shows a first example of a propulsion mechanism of a mobile robotic device according to the invention. The propulsion mechanism 30 is arranged to be able to replace the various propulsion mechanisms 20 of the device 1 of FIG. 1. It comprises a drum 32, an Archimedean screw thread 33 and rolling members 34. Each drum 32 has a hollow cylinder, open at one end and terminated at a second end by a dome 321. The Archimedean screw thread 33 is mounted integrally on the outer surface of the drum 32. It extends spirally on the drum 32 between the first and the second end and extends over the dome 321 to its top.

The propulsion mechanism 30 shown in FIG. 3A differs from the propulsion mechanism 20 shown in FIG. 1 by the rolling members 34, shown in more detail in FIGS. 3B to 3D. The rolling member 34 includes a support structure 341 and a wheel 342. FIG. 3B shows a complete rolling member 34, the wheel 342 being mounted on the support structure 341. FIG. 3C shows the single support structure 341 and FIG. 3D shows the wheel 342 alone. The support structure 341 has a shape and dimensions arranged to form a portion of the Archimedean screw thread 33. It comprises a housing 3411 configured to accommodate the wheel 342 and in particular leading to the lower 3412 and upper 3413 surfaces. However, relative to the support structure 241 of FIG. 2, the support structure 341 forms a lattice structure at the housing 3411. In this case, the support structure 341 comprises, on either side of the housing 3411, a first beam 3414 joining the two edges of the housing 3411 at the upper surface 3413 along the thread profile 33, a second beam 3415 joining one of the edges of the housing 3411 at the lower surface 3412 to a midpoint of the first beam 3414 and a third beam 3416 joining the other side of the housing 3411 at the lower surface 3412 to the midpoint of the first beam 3414. The openings 3417 are thus formed between the beams 3414, 3415 and 3416, an opening 3418 is likewise formed between the outer surface of the drum 32 and the beams 3415 and 3416. The openings 3417 and 3418 are through-holes. In other words, they pass through the support structure 341 from side to side along an axis parallel to the axis of rotation of the wheel 342.

In FIGS. 3B and 3C, the support structure 341 is shown without a pin. Of course, it could be provided with pins for fixing by locking of the rolling members 34 on the drum 32. Furthermore, in FIG. 3A, the rolling members 34 are shown as forming the modular elements of the Archimedean screw thread 33. However, different support structures 341 could be made integrally with the drum 32, for example by an injection moulding process or by three-dimensional printing.

The wheel 342 shown in FIGS. 3B and 3D differs from the wheel 242 of FIG. 2 in that it includes a hub 3421, a rim 3422, a tire 3423 and spokes 3425. The hub 3421 forms an axis of rotation to the wheel 342. The tire 3423 is mounted on the rim 3422 and is intended to come into contact with the ground. The rays 3425 extend radially between the hub 3421 and the rim 3422. There are three of them and they are separated from one another, so that they form through-openings for the wheel. Each beam 3425 has a frustoconical shape, so as to avoid the formation of parallel surfaces between the wheel 342 and its support structure 341.

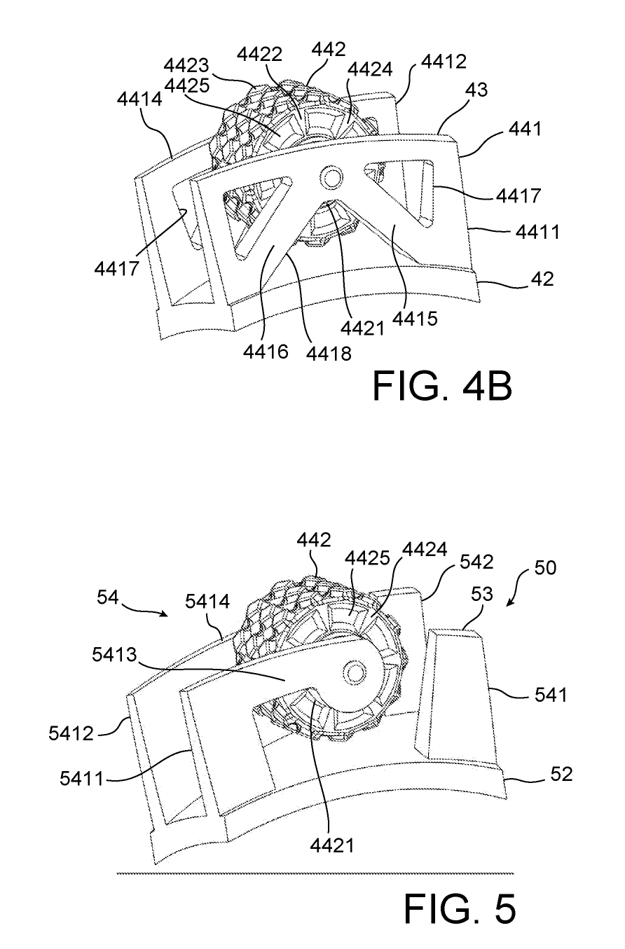

FIG. 4A shows a second example of propulsion mechanism of a mobile robotic device according to the invention. The propulsion mechanism 40 comprises a drum 42, an Archimedean screw thread 43 and the rolling members 44. FIG. 4B shows in detail a rolling member 44. The rolling member 44 includes a support structure 441 and a wheel 442. The support structure 441 comprises two walls 4411, 4412 extending parallel in a spiral on the outer surface of the drum 42. Each wall 4411, 4412 may be considered an Archimedean screw thread. Each wall 4411, 4412 is formed by a lattice structure in the wheel 442. This lattice structure is similar to that of the rolling member 34. Thus, the support structure 441 comprises beams 4414, 4415 and 4416, the recesses 4417 formed between these beams and a recess 4418 between the beams 4415, 4416 and the outer surface of the drum 42. The wheel 442 of each rolling member 44 has a relatively substantial width, adapted for example for relatively soft soils. Each wheel 442 comprises a hub 4421, a rim 4422, a tire 4423 and two side walls 4424. The hub 4421 forms an axis of rotation for the wheel 442. The tire 4423 is mounted on the rim 4422. The side walls 4424 extend radially between the hub 4421 and the rim 4422. They have the particularity of comprising recesses 4425 facing the walls 4411 and 4412.

FIG. 5 shows a detail of a third example of a propulsion mechanism of a mobile robotic device according to the invention. The propulsion mechanism 50 includes, as do other embodiments, a drum 52, an Archimedean screw thread 53 and rolling members 54. Each rolling member 54 includes a support structure 541 and a wheel 442, identical to the wheel the FIG. 4. The support structure 541 differs however in that the walls 5411, 5412 are each arranged to form, at each wheel 442, a flexible arm 5413, 5414 having one end integral with the rest of the support structure 541 and therefore of the drum 52 and the other end carries the hub 4421 of the wheel 442. The material and the dimensions of the arm are determined so that the flexible arms are capable of deforming elastically under the effect of an external force, for example a force applied to the wheel 442 in a normal direction to the local surface of the drum 52 or a force generated by the introduction of a foreign body between the side wall 4424 of the wheel 442 and an arm 5413 or 5414. The arms 5413, 5414 are constituted by beams following the Archimedean screw profile 53. However, the arm could have a different shape, for example following a more or less complex curvature.

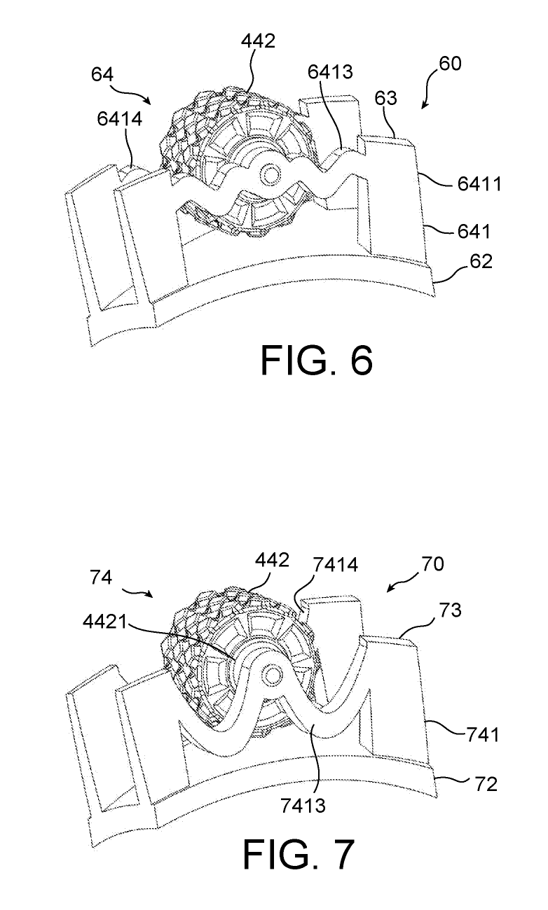

FIG. 6 shows a detail of a fourth example of a propulsion mechanism of a robotic device according to the invention. The propulsion mechanism 60 also includes a drum 62, an Archimedean screw thread 63 and rolling members 64. Each rolling member 64 includes a support structure 641 and a wheel 442 identical to the wheel of FIG. 4. The support structure 641 differs from the support structure 541 of FIG. 5 in that each of the walls 6411, 6412 is arranged to form a flexible arm 6413, 6414 both ends of which are integral with the rest of the support structure 641 and therefore of the drum 62. The arms 6413, 6414 extend between their attachment points along a winding profile. The hub 4421 of the wheel 442 is mounted with a pivot connection on the arm 6413, 6414 at a median point of these arms. The flexibility of the arms 6413, 6414 is provided by the choice of the material thereof and by their dimensions.

FIG. 7 shows a detail of a fifth example of a propulsion mechanism of a robotic device according to the invention. The propulsion mechanism 70 includes a drum 72, an Archimedean screw thread 73 and rolling members 74. Each rolling member 74 includes a support structure 741 and a wheel 442 identical to the wheel of FIG. 4. The support structure 741 differs from the support structure 641 of FIG. 6 by the profile of the flexible arms 7413, 7414. In this case, each flexible arm 7413, 7414 has two conic sections, a common end of which carries the hub 4421 of the wheel 442 and whose free ends are integral with the remainder of the support structure 741.

What is claimed is:

1. A mobile robotic device comprising a body and a propulsion mechanism, the propulsion mechanism comprising:
a drum adapted to be driven in rotation relative to the body,
an Archimedean screw thread integral with the drum and projecting with respect to an outer surface of the drum, and
rolling members each including a support structure and a wheel, each support structure forming a portion of the thread and each wheel being mounted with a pivot connection on the support structure so as to be driven in rotation by contact with the ground during rotation of the drum, each rolling member comprising at least one recess arranged to minimize the adjacent surfaces between the support structure and the wheel.

2. The device of claim 1, wherein at least one recess is formed in the support structure of each rolling member.

3. The device of claim 2, wherein at least one recess formed in the support structure of each rolling member has an opening through said support structure from one side to another along an axis parallel to an axis of rotation of the wheel, which is in a pivot connection with said support structure.

4. The device of claim 1, wherein each support structure forms a lattice structure.

5. The device of claim 1, wherein at least one recess is formed in the wheel of each rolling member.

6. The device of claim 5, wherein at least one recess formed in the wheel of each rolling member includes an opening through said wheel from one side to the other along an axis parallel to an axis of rotation of said wheel, which is in a pivot connection with the support structure.

7. The device of claim 6, wherein each wheel includes a hub, a rim and spokes extending radially between the hub and the rim, the spokes being separated from one other so as to form openings in the wheel.

8. The device of claim 7, wherein the spokes of each wheel have a cylindrical or frustoconical shape.

9. The device of claim 5, wherein each wheel includes a hub, a rim and a side wall, the side wall extending radially between the hub and the rim and facing a surface of the support structure, at least one recess being arranged to form a blind hole on the side wall.

10. The device of claim 9, wherein the wheel comprises a plurality of recesses circumferentially distributed on the side wall, each recess being arranged to form a blind hole on the side wall.

11. The device of claim 1, wherein the support structure of each rolling member is arranged to be able to deform under the effect of an external force.

12. The device of claim 11, wherein the support structure of each rolling member includes an arm of which a first end is integral with the drum and a second end carries a hub of the wheel, the arm being arranged to be able to flex under the effect of an external force.

13. The device of claim 11, wherein the support structure of each rolling member comprises an arm having a first end and a second end that are integral with the drum, a midpoint of the arm carrying a hub of the wheel, the arm being arranged to be able to flex under the effect of an external force.

14. The device of claim 11, wherein the support structure of each rolling member is formed from an elastic material.
